(19) United States
(12) Patent Application Publication
(10) Pub. No.: US 2006/0208697 A1
(43) Pub. Date: Sep. 21, 2006

(54) Gangable charger

(76) Inventors: Seng Chan, Suwanee, GA (US); John R. Johnson, Buford, GA (US); Kevin K. Kitts, Suwanee, GA (US)

Correspondence Address: MOTOROLA, INC.;LAW DEPARTMENT, 600 NORTH U.S. HIGHWAY 45, AS437, LIBERTYVILLE, IL, 60048, US

(21) Appl. No.: 11/081,193

(22) Filed: Mar. 16, 2005

(51) Int. Cl. H02J 7/00

(52) U.S. Cl. 320/116

(57) ABSTRACT

This invention is a battery charger capable of coupling to similar chargers so as to form an effective multi-unit charger that can be configured to a user's needs. The charger includes at least one pocket for accommodating a rechargeable battery pack. The charger is capable of linking to other chargers due to mechanical and electrical connection disposed on the charger. The charger has an external housing that includes a male electrical connector and a female electrical connector that facilitate linking similar chargers in a chain. A mechanical shroud is disposed about one of the electrical connectors, while a mechanical shroud recess is disposed about the other. A hemispherical linking flange extends from one side of the charger, while a linking flange recess is disposed along the other side. The mechanical and electrical connections of this charger allow multiple chargers to be linked together and still withstand the rigorous drop tests required by OEM manufacturers.

### TECHNICAL FIELD

This invention relates generally to chargers for rechargeable battery packs, and more specifically to a charger capable of being coupled together with other like chargers to form a multi-battery charger.

### BACKGROUND ART

Portable devices, like mobile telephones and two-way radios, rely upon rechargeable battery packs for their portability. For example, the rechargeable battery pack allows the policeman on the beat to stay in direct communication with the precinct at all times. Without such a portable, rechargeable battery pack, the policeman may only be able to communicate with the precinct while in a vehicle. Such limited communication could put the officer's safety at risk. In short, rechargeable batteries save lives.

Rechargeable batteries must, of course, be recharged to stay operational. There are many ways to do this. One may simply connect a power supply (by way of a wire and device specific connector) to an electronic device that includes an internal charger. Alternatively, one may decouple the battery pack from the host device, and charge it separately.

One of the most popular ways to charge batteries is with a desktop charger. A desktop charger is typically a device that includes a pocket into which either an electronic device with a battery pack coupled thereto or a stand alone battery pack may be placed. To recharge the battery, one simply inserts either the battery pack or host device into the pocket and the charging process begins. Annunciator devices, like text screens or lights, may update the user with the status of charge.

A problem with prior art chargers is that they come in two forms: the single unit charger and the multi-unit charger. The single unit charger has a single pocket into which one device may be inserted. The multi-unit charger typically has five to six pockets and is capable of charging as many devices simultaneously.

The problem with this single-unit/multi-unit dichotomy is that one is never certain how many devices will need to be charged at any one time. For instance, the precinct manager of the police department may have many devices to be charged. If the number of devices is for example 11, and multi-unit chargers accommodate 5 chargers each, the manager must either buy two multi-unit chargers and a single charger, or he must buy three multi-unit chargers. If he does the former, there is no room (unused pockets) for expansion of the fleet. If he does the latter, the third multi-unit charger has four open pockets that simply take up space on the desktop.

There is thus a need for a battery charger that accommodates varying battery fleet sizes.

### BRIEF DESCRIPTION OF THE DRAWINGS

FIG. 1 illustrates a top, left, front perspective view of a charger in accordance with the invention.

FIG. 2 illustrates a top, right, front perspective view of a charger in accordance with the invention.

FIG. 3 illustrates a pair of chargers coupled together in accordance with the invention.

FIG. 4 illustrates a pair of chargers coupled together in accordance with the invention.

FIG. 5 illustrates a cut-away view of a mechanical shroud and mechanical shroud recess coupling together in accordance with the invention.

FIG. 6 illustrates an electrical connector having snap-in contacts in accordance with the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

This invention is a charger capable of being both mechanically and electrically coupled together to similar chargers. Each charger has at least one pocket, and an effective multi-unit charger of at least n-pockets may be created by “ganging” n chargers together. Further, chargers in accordance with the invention are not only capable of coupling together, but are additionally capable of passing the rigorous “drop tests”, while ganged, required by OEM manufacturers.

In one preferred embodiment, a charger includes a pocket for receiving either a stand alone rechargeable battery pack or an electronic device coupled to a rechargeable battery pack. The pocket includes electrical contacts capable of supplying voltage and current from the charger to the battery pack. The charger may additionally include electronic circuitry that identifies the battery pack and/or ramps, steps, tapers or otherwise modulates voltage or current to properly charge the battery pack.

Manufacturers and marketers of electronic devices impose rigorous drop testing to all products sold. This drop testing ensures that your new $500 mobile phone will keep working after you inadvertently drop it in the parking lot. Drop testing requirements demand that an electronic device survive a finite number of drops, at a specified height, to a surface like carpet, wood or concrete. Experimental results with the present invention have shown that ten such chargers, coupled together, can withstand at least three drops at any angle from one meter to a wooden surface.

To survive such a rigorous drop test, a charger in accordance with the invention includes several mechanical mating features. Each of these features work together as a team to keep the charger gang together and functioning properly after being dropped. Each mechanical feature will be described in detail in the discussion of each of the following figures.

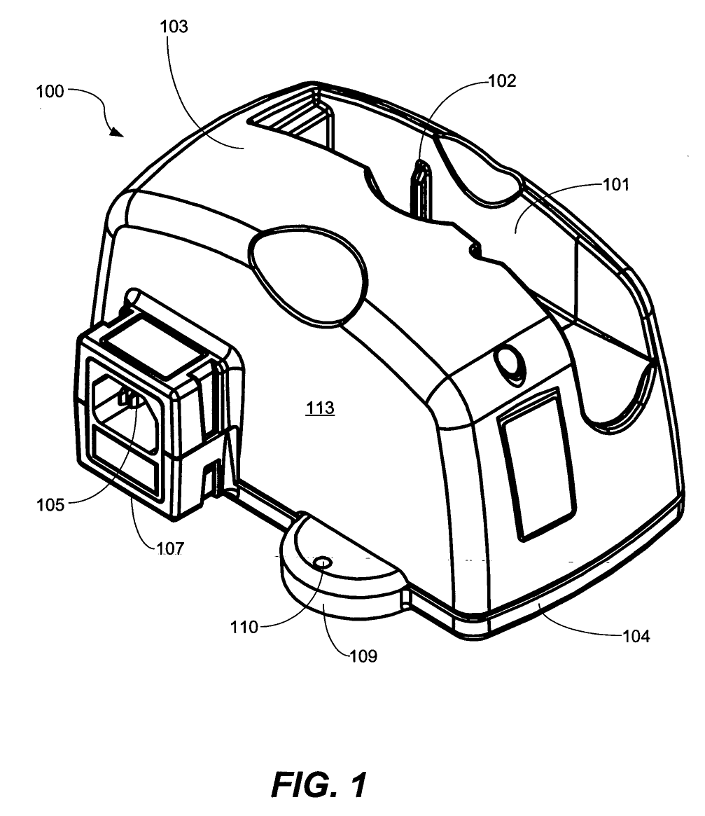

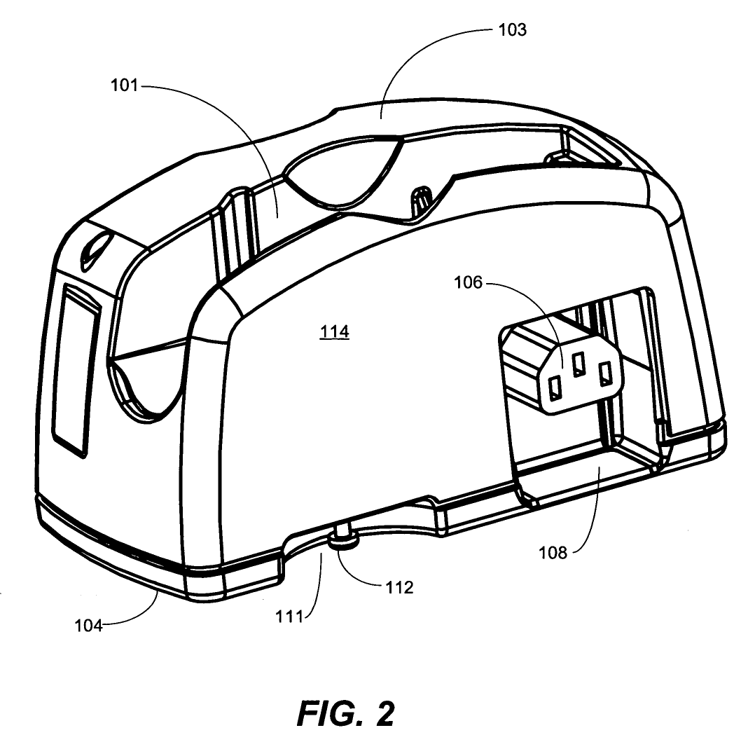

Turning now to FIGS. 1 and 2, illustrated therein are a top, front, left perspective view and a top, front, right perspective view, respectively, of a charger 100 in accordance with the invention. The charger 100 includes an exterior housing, which may be manufactured from a durable plastic such as ABS, polycarbonate or polycarbonate-ABS by way of an injection molding process. The exterior housing may include an upper exterior housing 103 and a base 104, which join together to house the charger's inner components.

The charger 100 includes at least one pocket 101 capable of accommodating any of a stand alone rechargeable battery pack, an electronic device having a battery pack coupled thereto, or an electrical connector that couples to a battery pack. The pocket 100 includes electrical contacts 102 capable of supplying voltage or current to the rechargeable battery pack. The electrical contacts 102 may be coupled to charging circuitry disposed within the charger 100.

The charger 100 includes at least a male electrical connector 105 and a female electrical connector 106. The male electrical connector 105 and female-electrical connector 106 are used to couple the charger 100 to other chargers. To facilitate coupling chargers 100 side by side, the male electrical connector 105 is disposed on a first side 113 of the charger 100, while the female electrical connector 106 is disposed on a second side 114 of the charger. The first side 113 and second side 114 may be on opposite sides of the charger 100, so as to facilitate a side-by-side linkage of ganged chargers. The male electrical connector 105 and female electrical connector 106 are complimentary in form factor so that one may be plugged into the other.

A mechanical shroud 107 is disposed about either the male electrical connector 105 or the female electrical connector 106. In the embodiment of FIGS. 1 and 2, the mechanical shroud 107 is disposed about the male electrical connector 105, although the invention is not so limited. It will be clear to those of ordinary skill in the art having the benefit of this disclosure that the mechanical shroud 107 could equally be disposed about the female electrical connector 106 as well.

A mechanical shroud recess 108 is included in the exterior housing of the charger for accommodating the mechanical shroud 107 when like chargers are coupled together. When the male electrical connector 105 is coupled to the female electrical connector 106, the mechanical shroud 107 fits within the mechanical shroud recess 108 to provide mechanical stability for the coupled set of chargers. As with the mechanical shroud 107, the mechanical shroud recess 108 could be disposed about either the male electrical connector 105 or the female electrical connector 106. In the exemplary embodiments of FIGS. 1 and 2, the mechanical shroud recess is disposed about the female electrical connector 106, and is on the opposite side 114 from the side 113 having the mechanical shroud 107.

A linking flange 109 extends outward from at least one side 113 of the battery charger 100. Where the exterior housing of the battery charger 100 includes an upper exterior housing 103 and a base 104, the linking flange 109 may extend outward from the base 104 of the charger 100. In one preferred embodiment, the linking flange 109 is hemispherical in shape and may include at least one aperture 110 through which a screw 112 may be inserted.

When chargers are coupled together, the linking flange 109 of one charger fits within a linking flange recess 111 that is complimentary in shape to the linking flange 109. For the chargers to be coupled side by side, the linking flange recess 111 is disposed on a side 114 opposite the linking flange 109.

As mentioned above, the linking flange 109 may include an aperture 110 through which a screw 112 may be inserted. Where the screw 112 is employed, the linking flange recess 111 will include a screw boss into which the screw 112 may be coupled. In one preferred embodiment, the linking flange 109 and mechanical shroud 107 are coupled on the same side 107 of the charger.

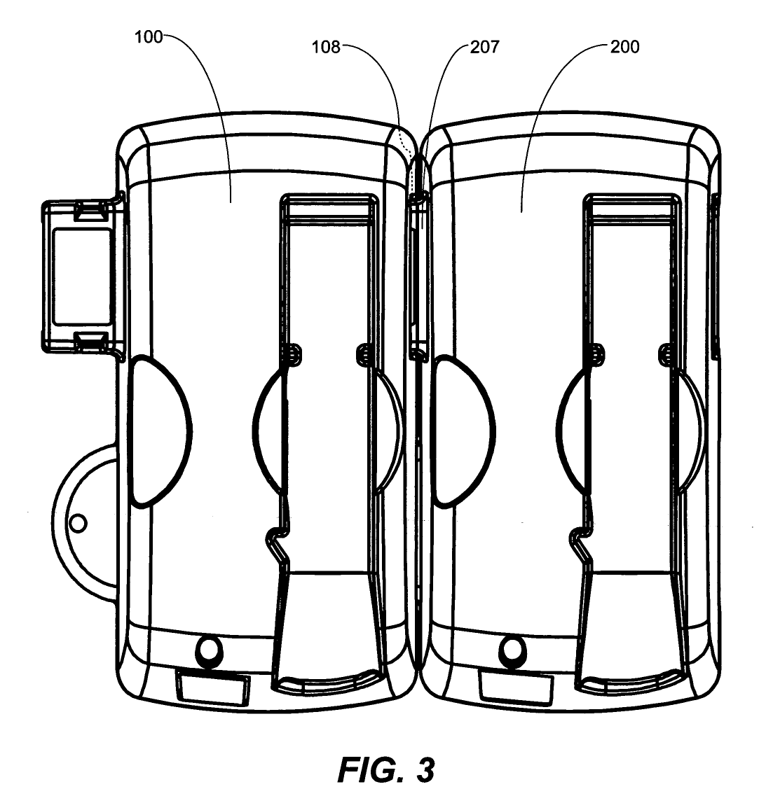

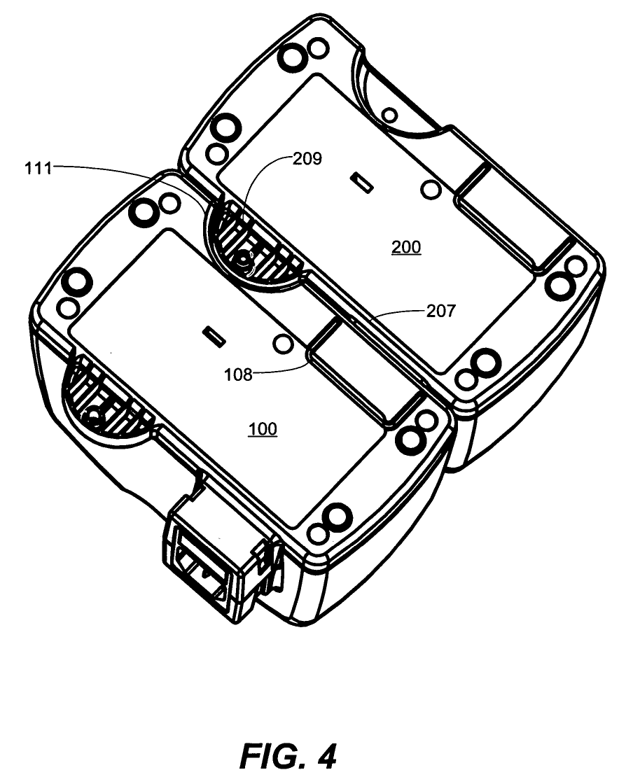

Turning now to FIGS. 3 and 4, illustrated therein are two chargers 100,200 that have been coupled together in accordance with the invention. FIG. 3 illustrates a top, plan view, while FIG. 4 illustrates a bottom, rear, left perspective view. As was discussed above, when coupling the chargers 100,200, the mechanical shroud 207 of charger 200 is inserted into the mechanical shroud recess 108 of charger 100 when the male electrical connector and female electrical connectors (not visible in these views) are coupled together. Similarly, the linking flange 209 of charger 200 inserts into the linking flange recess 111 of charger 100.

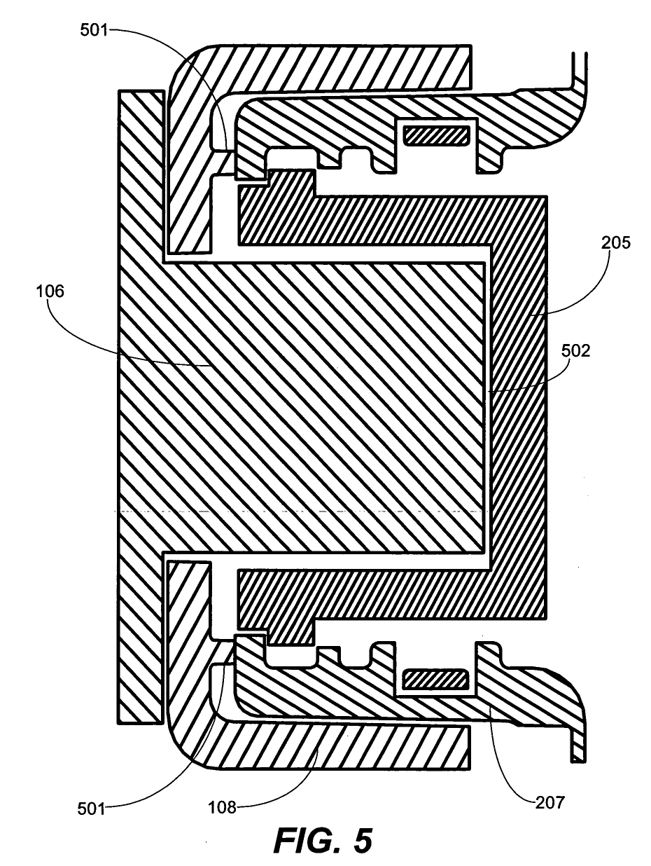

A screw 112 may be then used to couple the chargers 100,200 together using the linking flange 209. The connection between the male and female electrical connectors, the connection between the mechanical shroud 107 and the mechanical shroud recess 108, and the connection between the linking flange 209, the screw 112 and the linking flange recess 111 all work in concert to provide mechanical stability between linked chargers 100,200 during drop tests. To survive these violent drops, however, there must be some compliance in addition to the mechanical stability. Turning now to FIG. 5, one such source of compliance may be seen.

Illustrated in FIG. 5 is a cut away view of the connection between the male electrical connector 205 of charger 200 and the female electrical connector 106 of charger 100. Additionally, the interlock of the mechanical shroud 207 of charger 200 and the mechanical shroud recess 108 of charger 100 may also be seen.

If the male and female electrical connectors 205,106 were to mount flush against each other, the connection may be too rigid to pass the drop tests. Compliance between this connection is provided by two mechanical stop ribs 500,501 that are disposed within the mechanical shroud recess 108. These mechanical stop ribs 500,501 stop the mechanical shroud 207 from complete insertion within the mechanical shroud recess 108, thereby leaving a gap 502 between the male electrical connector 205 and the female electrical connector 106. This gap 502 provides room for “give” when coupled chargers are dropped. Stated differently, the mechanical, or “positive”, stop ribs 500,501 prevent contiguous mechanical contact between the faces of the housings of the male electrical connector 205 and female electrical connector 106.

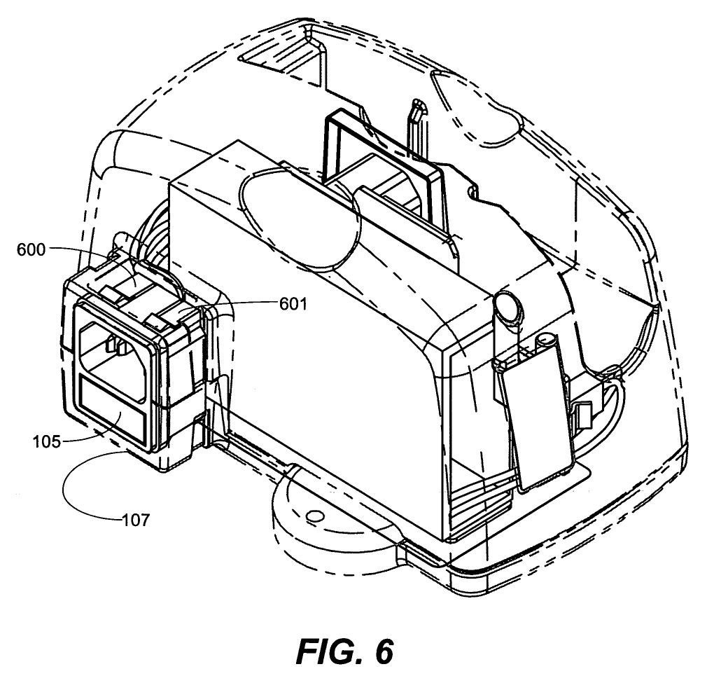

Turning now to FIG. 6, another source of compliance may be seen. This source of compliance is provided from snap-fit connectors 600,601 located atop and beneath the male electrical connector 105. The male and female electrical connectors, in one preferred embodiment, are mechanically “sandwiched” between the upper exterior housing and the base of the charger. By placing snap-fit connectors 600-601 on one of the electrical connectors, for example the male electrical connector 105 as shown in FIG. 6, that particular connector is compliant within the exterior housing of the charger. The snap-fit connectors 600,601, which are essentially springy, plastic cantilever type arms, serve as shock absorbers between the electrical connector and the exterior housing. As such, when coupled chargers are dropped, the snap-fit connectors 600,601 “give”, thereby absorbing some of the translated forces and thus keeping the chargers coupled together. The give provided by the snap-fit connectors additionally keeps the electrical connectors from fracturing during drop testing.

To summarize the present invention, a battery charger capable of mechanically and electrically coupling to another similar charger is provided. The battery charger includes an exterior housing having a pocket for receiving a rechargeable battery. The pocket includes electrical contacts disposed within the pocket for supplying voltage and current to the rechargeable battery. The charger has an exterior housing that has a male electrical connector disposed on a first side of the exterior housing, and a female electrical connector disposed on a second side of the housing (the first side is opposite the second side).

A mechanical shroud extends from the exterior housing. The mechanical shroud is disposed about either the male electrical connector or the female electrical connector. In one preferred embodiment, the mechanical shroud is disposed about the male electrical connector. A mechanical shroud recess, which is complimentary in shape to the mechanical shroud, is disposed about the other connector. For example, where the mechanical shroud is disposed about the male connector, the mechanical shroud recess would be disposed about the female electrical connector. The mechanical shroud recess includes positive stop ribs where the positive stop ribs prevent contiguous mechanical contact between the housing of the male electrical connector and the housing of the female electrical connector.

A hemispherical linking flange extends outward from a base of the battery charger. A linking flange recess, complimentary in shape to the linking flange, is disposed on the exterior housing opposite the linking flange. In one embodiment, the linking flange includes at least one aperture for accommodating a screw.

The present invention offers numerous advantages over prior art chargers. To begin, the gangable charger allows a battery manager to customize the charger by attaching the appropriate number of pockets to the ganged chain. This saves both cost, as only the appropriate number of chargers needs to be purchased, and desktop space, as there are no unnecessary pockets.

Next, as stated above, chargers in accordance with the invention are able to withstand rigorous drop tests. Experimental results have shown that ten chargers, coupled together, have been able to withstand three drops at worst case angles from one meter to wood. The mechanical and electrical coupling ensures a robust and reliable charger.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

What is claimed is:

1. A battery charger capable of being mechanically coupled to another charger, the battery charger comprising:
a. an exterior housing having a pocket for receiving a rechargeable battery;
b. electrical contacts disposed within the pocket for supplying a voltage and current to the rechargeable battery;
c. at least a male electrical connector and a female electrical connector, wherein the male electrical connector and female electrical connector are complimentary to each other and are disposed on opposite sides of the exterior housing;
d. a mechanical shroud disposed about an electrical connector selected from the group consisting of the male electrical connector and the female electrical connector; and
e. a linking flange extending outward from at least one side of the battery charger.

2. The charger of claim 1, further comprising positive stop ribs disposed within the mechanical shroud, wherein the positive stop ribs prevent contiguous mechanical contact between a housing of the male electrical connector and a housing of the female electrical connector.

3. The charger of claim 2, further comprising a mechanical shroud recess that is complimentary to the mechanical shroud.

4. The charger of claim 3, further comprising a linking flange recess that is complimentary to the linking flange.

5. The charger of claim 4, wherein the linking flange comprises at least one aperture for accommodating a screw.

6. The charger of claim 4, wherein the male electrical connector couples to the exterior housing with snap-fit connectors.

7. The charger of claim 6, wherein the mechanical shroud is disposed about the male electrical connector.

8. The charger of claim 7, wherein the mechanical shroud recess is disposed about the female electrical connector.

9. The charger of claim 8, wherein the linking flange and mechanical shroud are disposed on one side of the charger.

10. The charger of claim 9, wherein the mechanical shroud recess is disposed on a side opposite the side where the linking flange and mechanical shroud recess are disposed.

11. A battery charger capable of mechanically and electrically coupling to another similar charger, the battery charger comprising:
a. an exterior housing having a pocket for receiving a rechargeable battery;
b. a male electrical connector disposed on a first side of the exterior housing, and a female electrical connector disposed on a second side of the housing, wherein the first side is opposite the second side;
c. a mechanical shroud extending from the exterior housing, wherein the mechanical shroud is disposed about an electrical connector selected from the group consisting of the male electrical connector and the female electrical connector; and
d. a hemispherical linking flange extending outward from a base of the battery charger.

12. The charger of claim 11, further comprising electrical contacts disposed within the pocket for supplying a voltage and current to the rechargeable battery.

13. The charger of claim 12, further comprising positive stop ribs disposed within the mechanical shroud, wherein the positive stop ribs prevent contiguous mechanical contact between a housing of the male electrical connector and a housing of the female electrical connector.

14. The charger of claim 13, further comprising a mechanical shroud recess that is complimentary in shape to the mechanical shroud.

15. The charger of claim 14, further comprising a linking flange recess that is complimentary to the linking flange.

16. The charger of claim 15, wherein the linking flange comprises at least one aperture for accommodating a screw.

17. The charger of claim 16, wherein the male electrical connector couples to the exterior housing with snap-fit connectors.

18. The charger of claim 17, wherein the linking flange and mechanical shroud are disposed on the same side of the charger.

19. The charger of claim 18, wherein the mechanical shroud recess is disposed on a side opposite the side where the linking flange and mechanical shroud recess are disposed.
